(19) United States
(12) Patent Application Publication
(10) Pub. No.: US 2019/0069576 A1
(43) Pub. Date: Mar. 7, 2019

(54) Solid Form Nutrient Compositions

(71) Applicant: Railsplitter Feed Technology, Inc., Wildwood, MO (US)

(72) Inventor: Bud Harmon, Wildwood, MO (US)

(73) Assignee: Railsplitter Feed Technology, Inc., Wildwood, MO (US)

(21) Appl. No.: 16/078,281

(22) PCT Filed: Feb. 21, 2017
(86) PCT No.: PCT/US17/18746

§ 371 Date: Aug. 21, 2018

Related U.S. Application Data
(60) Provisional application No. 62/298,201, filed on Feb. 22, 2016.

(30) Foreign Application Priority Data
Feb. 22, 2016 (US) PCT/US16/18910

(51) Int. Cl. A23K 50/30; A23K 20/163; A23K 10/20; A23K 50/60; A23K 20/20; A23C 21/08; A23C 21/10

(52) U.S. Cl. CPC A23K 50/30; A23K 20/163; A23K 10/20; A23C 21/10; A23K 20/20; A23C 21/08; A23K 50/60

(57) ABSTRACT

Solid form nutrient compositions for use in delivering nutrients, such as iron sources, to plants and animals, including infant pigs, are provided. Embodiments include such solid form nutrient compositions, methods for making such compositions, compositions made by such methods, and methods for delivering nutrients to plants or animals with such compositions.

Nutrient delivery is an important and challenging process for both animals and plants. For example, iron deficiency is a serious health hazard for young animals, and in particular, to infant pigs. Typically, the greatest danger of iron deficiency anemia occurs within the first three or four weeks of life of the infant pig. During this period, the infant pig lives by natural preference on sow's milk which has a very low iron content and, therefore, is insufficient to provide the necessary iron infant pigs require. Iron deficiency anemia in infant pigs may result from a low iron content in the sow's milk, low amount of available iron in the pig's environment, and a rapid rate of growth—quadratic increase from birth weight in 21 days. Historically nursing pigs were on dirt and acquired adequate iron but in the pristine highly sanitized environment of modern swine production facilities, pigs cannot acquire adequate iron and anemia can result. Left unchecked, iron deficiency in infant pigs can lead to serious health consequences including death since such pigs are unable to biosynthesize sufficient hemoglobin to sustain bodily functions. Milk is deficient in iron providing only about 1 mg per liter of milk. The daily requirement is about 7 mg per day at birth which rapidly increases to 16 mg per day and to 25 mg per day prior to weaning. Exacerbating this challenge, due to modern genetics and breeding practices, pigs grow faster today than in the past. Modern agricultural techniques rely heavily on parenteral injections of iron to reduce anemia. These injections are invasive and the procedures are labor intensive, expensive, and increases the risk of microbial infections.

With respect to plants, nutrients, such as iron, are important for plant growth such as in the ornamental horticulture industry. Plants such as hydrangea, azaleas, and rhododendrons have substantial iron needs requiring significant amounts of iron.

In the current invention, solid form nutrient compositions are provided which may be used to successfully deliver iron to infant pigs and which are able to withstand typical feeding conditions, yet soft enough, when in the form of blocks, so that the pigs will ingest the compositions. The solid form compositions of the invention further include granular materials. Such solid form nutrient compositions may also be used to deliver nutrients such as iron to plants in need of such nutrients.

Solid forms as feed blocks are known in the art and have been used, for example, to provide feedstuffs to cattle and pigs. Such blocks are intended to be hard, weather resistant, and have been prepared with animal feed to deliver sources of energy and nutrients to animals. For example, U.S. Pat. No. 4,171,379, incorporated herein by reference, describes blocks which have been prepared with nutritional supplements for delivery to pigs. However, such blocks are not commonly used in the industry today because, although the intent is to make hard blocks, such blocks are often too hard for infant pigs to chew and fail to deliver sufficient overall nutrition to pigs.

### SUMMARY OF THE INVENTION

In some aspects of the invention, solid-form nutrient compositions comprising a nutrient, a carbohydrate energy source, one or more nutritional fillers, and milk solids is provided.

In some other aspects of the invention, solid-form nutrient compositions comprising a nutrient, a molasses, one or more nutritional fillers, and milk solids is provided.

In further aspects of the invention, processes for making solid form nutrient compositions comprising a nutrient are provided which processes comprise combining a molasses, a nutrient source, milk solids, and a nutritional filler, to form a mixture and treating the mixture with a metal oxide to form a solid form nutrient composition are provided.

In further aspects of the invention, solid form nutrient compositions in the form of blocks comprising a nutrient, a molasses, a nutritional filler, water, a promoting agent, a dispersant, a metal oxide, milk solids, a sweetener, and a synthetic flavoring substance are provided.

In yet additional aspects of the invention, solid form nutrient compositions comprising a nutrient, a molasses, and one or more nutritional fillers and wherein the composition contains substantially no clay fillers, is provided.

Additional aspects of the invention include solid form nutrient compositions comprising, by weight, between about 7% and 13% of a nutrient, between about 49% to about 59% of a molasses, between about 4% and 10% of nutritional fillers, and between about 2% and 12% of milk solids.

Further aspects of the invention include solid form nutrient compositions comprising, by weight, between about 8% and 10% of a nutrient, between about 50% and 55% of a molasses, between about 5% and 8% nutritional fillers, and between about 4% and 8% milk solids.

In still further aspects of the invention, solid form nutrient compositions in the form of blocks comprising water, cane molasses, a nutrient, soybean oil, milk solids, nutritional fillers, magnesium oxide, and tetrasodium pyrophosphate are provided.

Additional aspects of the invention include methods for increasing the hemoglobin content of infant pigs comprising feeding said pigs a solid form nutrient composition of the invention. Further aspects of the invention include methods for preventing anemia in infant pigs comprising feeding said pigs a solid form nutrient composition of the invention.

A further aspect of the invention includes solid form nutrient compositions comprising one or more kinds of molasses, one or more nutritional fillers, an iron source, and a metal oxide wherein the solid form nutrient compositions are in granular form.

Another aspect of the invention includes solid form nutrient compositions comprising, by weight, between about 6% and about 20% whey permeate, between about 27% and about 36% dry cane molasses, between about 5% and 27% cane molasses, between about 10% and about 27% corn flour, between about 7% and about 25% wheat middlings, between about 7% and 13% of ferrous sulfate monohydrate, between about 1% and 2% magnesium oxide, and between about 1% and 2% of tetrasodium pyrophosphate, and wherein the solid form nutrient compositions are in granular form.

In a further aspect of the invention, solid form nutrient compositions in the forms of blocks are provided comprising, by weight, between about 48% to about 54% cane molasses; between about 4% and about 20% whey permeate, between about 10% and about 14% ferrous sulfate monohydrate, and between about 0.5% and about 5% oat groats.

In a still further aspect of the invention, pre-block compositions are provided comprising by weight about 48% to about 54% cane molasses, about 5% to about 20% added water, between about 6% and about 20% whey permeate, between about 10% and about 14% ferrous sulfate monohydrate, and between about 0.5% and about 5% oat groats.

In an additional aspect of the invention, solid form block compositions prepared by combining a mixture comprising cane molasses, water, soybean oil, and methyl anthranilate with a mixture comprising whey permeate, nutritional fillers, and ferrous sulfate monohydrate, a dispersant and a metal oxide to form a liquid; and drying the liquid in a container to form blocks are provided.

### DETAILED DESCRIPTION

As used herein, the term “solid form nutrient composition” means a nutrient composition of the invention in a solid form suitable for use under typical feeding conditions for animals or for nutrient delivery for plants. Solid forms include, but are not limited to, blocks and granular materials. Such solid forms are sufficiently weather and use resistant such as to enable the delivery of nutrients to animals or plants. For example, such solid forms may be used to deliver iron to infant pigs. The solid form nutrient compositions may be in the form of blocks wherein the blocks are used by infant pigs, typically without substantial staining of the skin of the infant pigs and sufficiently soft so that the pigs consume the blocks. Such solid form nutrient compositions may also be in the form of granular materials. When delivered in solid forms, such as in blocks or granular materials, pigs are able to ingest requisite iron without the need for expensive, invasive, and potentially unsanitary delivery of iron through injections. When used in the form of blocks, solid-form nutrient compositions of the disclosure are sufficiently chewable so that pigs consume them. If too dry, blocks may lose their attractiveness to pigs who then will not eat them and fail to gain the sought-after nutrients.

The term “a” such as when referring to a component of a solid form nutrient composition of the invention, such as “a carbohydrate energy source” denotes while a single carbohydrate energy source is present, the presence of additional carbohydrate energy sources is not precluded in said composition of the invention. Likewise, the term “one or more” in the same context, such as in “one or more nutritional fillers” also means that whereas one nutritional filler is present, an additional one may also be present as could multiple additional nutritional fillers.

Ranges can be expressed herein as between “about” one numerical value and “about” another numerical value (e.g. “between about 10% and about 20%”). When such a range is expressed, another embodiment includes a range between one or both precise numerical values (e.g. “between 10% and 20%”). The term “between” as used herein includes the recited endpoints of the ranges. Similarly, individual numerical values can be expressed herein with use of the antecedent “about” (e.g. “about 10%”). It will be understood that the precise numerical value (e.g. “10%”) also forms an additional embodiment in those instances.

While the nutrient in the solid form nutrient compositions may be any nutrient, in many embodiments at least one nutrient is an iron source. Iron is necessary for pig growth and thriving. Any source of iron may be used which is bioavailable to pigs when given orally. Commonly available and inexpensive sources of iron such as ferrous sulfate monohydrate may be used.

While in many embodiments, at least one nutrient is iron, the solid forms may be used to deliver nutrients other than or in addition to iron. The term “nutrient” is meant to include any compound or composition which may be helpful for the growth or maintenance of animals or plants and which is capable of being formulated into a solid form of the invention. In addition to iron and iron-based nutrients, such as iron sources, nutrients include dietary minerals, phytase, vitamins, antibiotics, antimicrobials, anti-viral agents, immunoglobulins, or vaccines. Examples of vitamins include vitamin A, vitamin B12, vitamin D, vitamin E, vitamin C, and vitamin K. Examples of dietary minerals include calcium, phosphorus, potassium, sulfur, sodium, chlorine, magnesium cobalt, copper, zinc, manganese, molybdenum, iodine, bromine, and selenium. Examples of antimicrobials include water-insoluble antibiotics unavailable for injection such as carbadox. Other examples of nutrients include acidifiers, which tend to alter pH levels in the gut thereby reducing harmful bacterial growth such as E. Coli may be used. Examples of anti-viral agents include copper sulfate anhydrous, or hydrated copper sulfate such as copper sulfate pentahydrate and/or zinc oxide. When the nutrient is an iron source, that source can be any iron in any form that is bioavailable. Such iron sources include iron salts. Example of iron salts, include ferrous chloride, ferrous sulfate, ferric ammonium citrate, ferrous fumarate, ferrous lactate, ferrous maleate, ferric acetate, ferric chloride, ferric citrate, ferrous proteinate, and ferric succinate. Hydrated salts of iron may be used such as ferrous sulfate monohydrate.

In many embodiments of the invention, the solid form nutrient composition is prepared with a carbohydrate energy source. The carbohydrate energy source typically provides a substantial part of the solid form nutrient composition and can be chemically hardened to form a block in many embodiments of the invention. One example of a carbohydrate energy source is molasses, such as cane molasses. Any commercially available molasses may be used. For example, other carbohydrate energy sources are blackstrap molasses, converted molasses, dry cane molasses, citrus molasses, and wood sugar molasses. Other carbohydrate energy sources are sugar or carbohydrates with sugars added such as cornmeal and sucrose.

In many embodiments of the invention, one or more nutritional fillers are included. Such fillers may be wheat middlings, corn flour, such as degerminated corn flour, corn cob meals, oat groats, and the like. In addition to providing nutrition such as calories and protein, such fillers provide bulk and mass for the block. Nutritional fillers do not include clays because clays do not contribute nutritional value.

Clays have often been used in animal feed blocks as fillers in the past. Such clays are often water absorbent. Typical clays that have been used include attapulgite clay, bentonite, kaolin, and mixtures thereof. While clays may be used in some embodiments of the invention, in many embodiments of the invention, the solid form nutrient compositions use only nutritional fillers and are, therefore, free or substantially free of clay fillers. Examples where clay fillers may be used include compositions of less than about 1% by weight.

Other additives may also be used in the solid form compositions of the invention. For example, agents for promoting the formation of solid forms, “promoting agents”, may be used. Examples of such agents include, but are not limited to, animal and vegetable fats and oils. Typical oils include soybean oil, canola oil, and fish oil. Optionally, solid fats may be used with the solid form nutrient composition. Such solid fats include grease, bleachable fancy tallow, yellow grease, beef fat, lard, and the like. In many embodiments of the invention, a promoting agent as a liquid fat or oil is a component of the solid form nutrient composition and no solid fat is added as a component.

Setting agents may also be used in the solid form nutrient compositions of the invention. Setting agents quicken the setting time of the formation of the solid form during processing. Ferrous sulfate monohydrate, which is an iron source, may also act as a setting agent. Other setting agents may be used in addition to ferrous sulfate monohydrate. Iron sources may serve both as a nutrient and as a setting agent.

The solid form nutrient compositions of the invention may also further comprise a dispersant. A dispersant, may be used to disperse the fillers of the solid form composition. Examples of dispersants include tetrasodium pyrophosphate and monoammonium phosphate.

In many embodiments of the invention, a sweetener may be added to assist in attracting animals, such as infant pigs, to the solid form nutrient composition. An example of such a sweetener is sucrose. Other sweeteners which may be used are non-caloric sweeteners such as aspartame and/or saccharin. In these and other embodiments, flavorings may also be used. Examples of flavorings include any commercially available flavoring such as red berry, dairy, and strawberry flavorings. Synthetic flavoring substances may also be used such as methyl anthranilate.

Milk solids are used as components in many embodiments of the invention. Milk solids are solids which are isolated from milk. A commonly used milk solid is whey permeate. Typically, whey permeate comprises over 50% lactose. Often, whey permeate comprises over 60% lactose. Other embodiments include lactose contents of over 80%. One example is an embodiment with a lactose content of 84%.

Blocks may be made by any number of routes including those set forth in U.S. Pat. Nos. 4,265,916; 7,348,019; and 4,904,486 as well as WO2015/048451, all of which are incorporated herein by reference. For example, blocks may be prepared by combining a molasses with suitable metal oxides such as magnesium oxide to make mixtures. The addition of magnesium oxide in such embodiments typically induces an exothermic chemical reaction and causes the mixture to start to solidify through the reaction, primarily, with the molasses. Magnesium oxide is often selected because the reaction kinetics are usually more robust when compared with other metal oxides. When making solid form nutrient compositions in the form of a block, it is typically not necessary to prepare such blocks by compression when hardening is done by an exothermic reaction such as with the addition of magnesium oxide. Water may be used as the medium for the exothermic reaction between, for example, cane molasses and magnesium oxide. The resulting mixtures may be poured into a mold and cured and set within the mold.

Curing may be done up to 12, 24, 36, or 48 hours. Examples of curing temperatures are between room temperature and 120° F. Setting may be done at elevated temperatures, room temperature, or below. Possible molds include two-ounce cups and 5.5-ounce cups. Blocks typically have a mass of less than about 250 grams, including less than about 200 grams. Other sizes of blocks include between about 100 grams and 200 grams including any value in between. In many embodiments, the block size is about 145 grams or about 160 grams. The size of the block is dependent on the amount of material made and the size of the mold or the cup. Other ingredients of the inventions may be added during the formation of the blocks. A general example of block formation may be found in Example 1.

Granular forms of the invention typically do not include added liquid water and thus may be considered substantially anhydrous when prepared. Once exposed to ambient conditions, however, such granular materials may absorb moisture.

Granular forms of the solid form nutrient composition may be made without milk solids. In such embodiments, different kinds of molasses may be used such as cane molasses, dry cane molasses, or a combination thereof. In such embodiments, the overall amount of molasses typically is found between about 12% and about 35% including any value in between. Thus, whether only cane molasses is used, only dry molasses is used, or a combination of the two is used, the total amount of molasses may be about 13%, 14%, 15%, 16%, 17%, 18%, 19%, 20%, 21%, 22%, 23%, 24%, 25%, 26%, 27%, 28%, 29%, 30%, 31%, 32%, 33%, or 34%. Nutritional fillers are also used in such embodiments in an amount typically between about 50% and 60%, including any value in between, by weight. Often, both corn flour, such as degerminated corn flour, and wheat middlings are combined for use as nutritional fillers in such embodiments. Thus, the total amount of nutritional filler, whether wheat middlings alone, corn flour alone, or both together, may be about 51%, 52%, 53%, 54%, 55%, 56%, 57%, 58%, or 59% by weight. Such embodiments further have between about 7% and 13%, and any value in between, of a nutrient such as an iron source. For example, the iron source may be ferrous sulfate monohydrate. Thus, for example, the embodiments include 8%, 9%, 10%, 11%, or 12% of a nutrient source such as ferrous sulfate monohydrate. Other components include between about 1% and 4% of a metal oxide such as magnesium oxide including any value in between such as about 2% or 3%. Further, a dispersant such as tetrasodium pyrophosphate may be used between about 1% and 3% including any value in between such as about 2%. Flavorings, such as berry or dairy flavorings, together with sweeteners, such as saccharin, are together present at levels of totaling less than about 1%. Such embodiments may further include a promoting agent such as soybean oil in levels of less than or equal to about 4% such as 1%, 2% or 3%.

In other embodiments of the invention, solid form nutrient compositions as granular materials with milk solids are provided. In such embodiments, the amount of milk solids used is typically between about 6% and 20%, including any value in between such as about 7%, 8%, 9%, 10%, 11%, 12%, 13%, 14%, 15%, 16%, 17%, 18%, or 19%. Whey permeate is a typical milk solid. Other ranges include between about 8% and 12% and between about 16% and 19%. Such embodiments further include a carbohydrate energy source which often comprises two kinds of molasses: dry cane molasses and cane molasses. Such embodiments typically have between about 17% and about 50% combined dry cane and cane molasses. When considered separately, the amount of dry cane molasses is typically between about 17% and 40%, about 27% and 36%, or between about 32% and about 36%, and any value in between the broadest range presented such as about 18%, 19%, 20%, 21%, 22%, 23%, 24%, 25%, 26%, 27%, 28%, 29%, 30%, 31%, 32%, 33%, 34%, 35%, 36%, 37%, 38%, or 39%. The amount of cane molasses in such embodiments typically ranges between about 5% and 27%, including between about 7% and 14% and between about 9% and 11% including any value in between the largest range presented. Thus, about 6%, 7%, 8%, 9%, 10%, 11%, 12%, 13%, 14%, 15%, 16%, 17%, 18%, 19%, 20%, 21%, 22%, 23%, 24%, 25%, or 26% are included.

Such granular nutrient composition embodiments further include nutritional fillers in an amount typically between about 18% and 52%, including any value in between, by weight. Often, both corn flour, such as degerminated corn flour, and wheat middlings are combined for use as nutritional fillers in such embodiments. When considered separately, the amount of corn flour is between about 10% and 27% and any value in between such as about 11%, 12%, 13%, 14%, 15%, 16%, 17%, 18%, 19%, 20%, 21%, 22%, 23%, 24%, 25%, or 26%. Other ranges include between about 18% and 22% and between about 10% to 13%. The amount of wheat middlings in such embodiments typically ranges between about 7% and 25% and any value in between, such as 8%, 9%, 10%, 11%, 12%, 13%, 14%, 15%, 16%, 17%, 18%, 19%, 20%, 21%, 22%, 23%, or 24%. Other ranges include between about 20% and 25% and between about 8% and 10%. Such embodiments also have between about 7% and 13%, and any value in between, of a nutrient such as an iron source. The iron source may be ferrous sulfate monohydrate. Thus, for example, the embodiments include about 8%, 9%, 10%, 11%, or 12% of a nutrient source such as ferrous sulfate monohydrate. Other components include between about 1% and 2% each of a metal oxide such as magnesium oxide and a dispersant such as tetrasodium pyrophosphate. Flavorings, such as berry or dairy flavorings, together with sweeteners, such as saccharin, are together present at levels of less than about 1% and are often about 0.4% each. A synthetic flavoring substance such as methyl anthranilate may be used in an amount of less than 0.1% and typically between about 0.03% and 0.07% including any value in between such as about 0.04%, 0.05% or 0.06%.

In some embodiments of the invention, a solid form nutrient composition in the form of a block where no milk solids are present is provided wherein the weight percentage of cane molasses is between about 54% to 62% by weight, including any value in between such as 55%, 56%, 57%, 58%, 59%, 60%, or 61%. In such embodiments, the weight percent of water may be between about 5% and 13%, including any value in between such as about 6%, 7%, 8%, 9%, 10%, 11%, or 12%. Such embodiments further include between about 7% and 13%, including any value in between, of a nutrient such as an iron source. A common iron source is ferrous sulfate monohydrate. Thus, values such as 8%, 9%, 10%, 11%, or 12% are included. In addition, between about 3% and 6% magnesium oxide by weight, including any value in between such as about 4% and 5% is present. Such embodiments further include between about 7% and 15% nutritional fillers including any value in between such as about 8%, 9%, 10%, 11%, 12%, 13%, or 14%. Examples of nutritional fillers include corn flour, such as degerminated corn flour and wheat middlings. Corn flour is often combined with wheat middlings in such combinations. Typical amounts of corn flour are between about 2% and 7% including any value in between such as about 3%, 4%, 5% or 6%. Typical amounts of wheat middlings are between about 4% and 10% including any value in between such as about 5%, 6%, 7%, 8%, or 9%. Such embodiments further contain between about 3% and 8% of a promoting agent such as soybean oil, including any value in between such as 4%, 5%, 6%, or 7%. Further included is a dispersant, such as tetrasodium pyrophosphate, in the amount of between about 1% and 4% by weight including any value in between such as about 2%, 3%, or 4%. Sweeteners and flavorings may also be added to such embodiments. Together, the amount of sweetener, such as saccharin, and flavoring, such as a berry flavoring total less than 1% and more typically, less than 0.5% combined.

The invention further includes solid form nutrient composition blocks which contain milk solids as components of the blocks. In such embodiments, the milk solids comprise between about 4% and 20% milk solids, including any value in between such as about 5%, 6%, 7%, 8%, 9%, 10%, 11%, 12%, 13%, 14%, 15%, 16%, 17%, 18%, or 19%. Other ranges include between about 4% and about 8%, between about 6% and about 12%, between about 8% and about 14%, between about 7% and about 20%, and between about 15% and about 20%. A common example of a milk solid as used herein is whey permeate. Such embodiments further include between about 7% and about 15% of a nutrient and further including any value in between such as about 8%, 9%, 10%, 11%, 12%, 13%, or 14%. Other ranges include between about 11% and about 13%. A common example of a nutrient is an iron source such as ferrous sulfate monohydrate. In some embodiments, the value is about 12% ferrous sulfate monohydrate. In such embodiments, between about 45% and 54%, including any value in between such as about 46%, 47%, 48%, 49%, 50%, 51%, 52%, or 53% of a carbohydrate energy source, such as cane molasses, is also provided. Other ranges of carbohydrate energy sources such as cane molasses include between about 48% and 54%, between about 48% and about 52%, and between about 52% and about 53%. Such embodiments further include ranges between about 0.5% and about 10%, between about 0.5% and about 5%, between about 0.5% and about 2.5%, between about 5% and about 8%, and between about 6% and about 7% of one or more nutritional fillers. Values in between about 0.5% and about 10% are included such as 1%, 2%, 3%, 4%, 5%, 6%, 7%, 8% or 9%. Nutritional fillers may be one or more of, for example, wheat middlings, corn flour, such as degerminated corn flour, or oat groats. When wheat middlings and corn flour, such as degerminated corn flour are used, the relative amounts of corn flour and wheat middlings may be the same or different. For example, one may use about 1%, 2%, or 3% each of wheat middlings and corn flour. In some embodiments, only oat groats and degerminated corn flour are used as such nutritional fillers.

In some embodiments, the nutritional filler is oat groats. In some embodiments, the only nutritional filler is oat groats. In these and other embodiments, ranges include between about 0.5% and about 5% of oat groats, between about 0.5% and about 2.5% of oat groats, and between about 0.5% and about 1.5% of oat groats.

Such embodiments may further include between about 5% and 20% and any value in between such as about 6%, 7%, 8%, 9%, 10%, 11%, 12%, 13%, 14%, 15%, 16%, 17%, 18%, or 19% of water. Other ranges include between about 10% and about 14% of water and also between about 10% and about 13% water. Such water levels may be in pre-block mixtures prior to curing. Other components within such embodiments may include between about 3% and about 7% or between about 4% and about 6% of a promoting agent such as soybean oil, including about 5%; and may further include between about 3% and about 7% or between about 3% and about 6% of a metal oxide such as magnesium oxide, including about 5%. Dispersants, such as tetrasodium pyrophosphate may be used in such embodiments. Examples of ranges include between about 2% and about 6% and between about 3% and about 4%. In some embodiments, no solid fats are added.

In these and other embodiments, the solid form nutrient block compositions may include sweeteners, flavorings, and synthetic flavoring substances. The total amount of such additives is typically less than about 2%. For example, the amount of sweetener and flavoring such as sucrose or saccharin for a sweetener or a flavoring such as a berry (such as red berry), strawberry, or dairy flavorings is typically between about 0.1% and 1% including about 0.2%, 0.3%, 0.4%, 0.5%, 0.6%, 0.7%, 0.8%, or 0.9% each of sweetener and flavoring. Other ranges include between about 0.4% and about 0.9%. The amount of synthetic flavoring substance, such as methyl anthranilate, may be between about 0.01% and about 0.1% including about 0.02%, 0.03%, 0.04%, 0.05%, 0.06%, 0.07%, 0.08%, or 0.09%. It also may be between 0.05% and 0.1% including about 0.1%.

The solid form nutrient compositions of the invention may be delivered to animals, such as infant pigs, or plants, such as in the form of a block or granular materials, to provide an oral route for bioavailable nutrients. For example, the invention includes methods of providing blocks comprising the solid form nutrient compositions herein containing iron sources such as ferrous sulfate, including ferrous sulfate monohydrate, to pigs such as infant pigs. Such delivery can be used to boost the blood levels of iron in the infant pigs and thus enable them to thrive and prevent anemia.

The invention includes processes for making solid form nutrient compositions such as blocks and granular materials. When making blocks, a general procedure is to combine and mix liquid ingredients, combine and mix dry organic feed ingredients, combine and mix flavor ingredients, and then combine and mix mineral ingredients. Once mixed, the combination may be poured into a container for heating and curing. Thus, a solid block may be formed in the container. Examples of liquid ingredients are cane molasses, water, soybean oil, and methyl anthranilate. Examples of dry organic feed ingredients are whey permeate, wheat middlings, and degerminated corn flour. Examples of flavor ingredients are sweeteners and flavors such as berry flavor. Examples of mineral ingredients are ferrous sulfate monohydrate, tetrasodium pyrophosphate, and magnesium oxide.

When making granular materials, a general procedure is to combine and mix dry ingredients, combine and mix in liquid ingredients, mix and air dry. This procedure results in a granular material. Examples of dry ingredients include dried cane molasses with beet sugar pulp absorbent, degerminated corn flour, wheat middlings, whey permeate, ferrous sulfate monohydrate, tetra sodium pyrophosphate, magnesium oxide, saccharin, and flavors. Examples of liquid ingredients include cane molasses, soybean oil, and methyl anthranilate.

The solid form nutrient compositions may be used as blocks to boost iron in animals by providing digestible iron. The blocks or granular materials may be adjusted in size and iron content to deliver a desired amount of iron. For example, a 100 gram block or granular material loaded with 9% ferrous sulfate monohydrate will contain about 2.95 grams of iron. By comparison, a 100 gram block or granular material loaded with 10.8% iron sulfate monohydrate will contain about 3.54 grams of iron.

In some embodiments, it would be desirable to provide a solid form nutrient composition, such as in the form of a block or granular material, that could deliver 25 mg of iron daily to an infant pig for 21 days. Assuming an average litter of 12.5 pigs, this translates into a block or granular material being able to provide about 6.56 grams of iron. At a 9% loading of ferrous sulfate monohydrate, the mass of such a composition would be about 226 grams.

In other embodiments, it may be desirable to provide a solid form nutrient composition, such as in the form of a block or granular material, where the amount of iron delivered would be sufficient to support 16 mg per day for 10 days and 25 mgs per day for the last 11 days of the 21-day period from birth. This amounts to a total of about 5.4 grams of iron for an average litter size of 12.5 pigs per litter. At a loading of 9% of ferrous sulfate monohydrate, the mass of such a composition would be 186 grams. It is worth noting that commercial suppliers of ferrous sulfate monohydrate often report an iron content that is less than would be expected stoichiometrically, presumably due to purity. Thus, one may wish to add additional ferrous sulfate monohydrate to take such impurities into account.

The solid form nutrient compositions as in block form may be placed in farrowing stalls such that the blocks are accessible to the pigs but unreachable for the sow. The blocks, which may be highly flavored, are licked, chewed and bitten by the pigs for the flavor but in doing so consume the needed iron to avoid anemia until weaned to dry diets. The block may be mounted on the panel on the stall off the floor for sanitation, but unavailable to the sows.

The blocks of the invention may also be used as a slow fertilizer for ornamental horticulture that has a high requirement for iron including hydrangea, azaleas and rhododendrons. For example, a 140 gram block provides slow release of ferrous sulfate monohydrate that can be easily placed in the ground near the base of the bush in ground buried, for example, about 1 inch below ground level. The blocks last at least 3 to 4 months with rain fall and sprinklers.

Having generally described the invention, reference to certain examples, which are provided herein for purposes of illustration only, and are not intended to be limiting, unless otherwise specified, may be helpful to help to illustrate certain embodiments of the invention.

### EXAMPLES

### Example 1—General Preparation of Solid Form Nutritional Animal Compositions of the Invention in the Form of Blocks

Liquid ingredients are first added to Mix Master Mixer or Hobart Type mixer in the following order: cane molasses, water, soybean oil, and methyl anthranilate, and mixed for about 3 minutes. The following dry feed ingredients are then weighed into the mixers while the mixers continue to run in the following order: whey permeate (when used), wheat middlings (when used), degerminated corn flour (“DCF”) (when used) and oat groats (when used). Afterwards, dry flavor ingredients (saccharin and flavorings such as berry or dairy flavorings) are then added to the mixers while in motion and mixing continues for about 2 minutes. Ferrous sulfate monohydrate (finely ground), tetrasodium pyrophosphate (“TSPP”), and magnesium oxide are then added while the mixer is in motion and are allowed to mix for about 8 minutes, resulting in a liquid capable of pouring.

The resulting liquid is poured and dipped into 5.5 ounce sealable plastic cups (˜160 grams per cup). The products in the cups are then allowed to cure at room temperature for about 4 hours. Once cured, the products are placed in a drying cabinet for about 36 hours at 120° F. for continued curing and solidification. Afterwards, snap-on plastic caps are placed on the cups. Once the blocks are removed from the cups, quarter inch holes are drilled for mounting the blocks on side panel of farrowing stalls so as to protect the blocks from fecal matter. The blocks are placed in a location to be accessible to infant pigs but not accessible to sows.

### Example 2

The following weight percent compositions for blocks as set forth in Tables 1-8 were made according to the general procedures of Example 1

TABLE 1

| Sample # | 229 | 230 | 231 | 232 | 233 |
|---|---|---|---|---|---|
| Cane Molasses | 60.0 | 59.3 | 58.5 | 58.4 | 58.4 |
| Water | 6.0 | 7.0 | 8.3 | 8.4 | 8.4 |
| FeSO₄•H₂O | 8.5 | 8.5 | 8.5 | 8.5 | 8.5 |
| Mg Oxide | 5.5 | 5.0 | 5.0 | 4.9 | 4.8 |
| Wheat Middlings | 10.0 | 10.0 | 9.0 | 9.0 | 8.0 |
| DCF | 2.0 | 2.0 | 2.5 | 2.6 | 3.7 |
| Soybean oil | 4.0 | 4.2 | 4.2 | 4.2 | 4.2 |
| TSPP | 3.7 | 3.7 | 3.7 | 3.7 | 3.7 |
| Saccharin | 0.1 | 0.1 | 0.1 | 0.1 | 0.1 |
| Berry Flavor | 0.2 | 0.2 | 0.2 | 0.2 | 0.2 |

TABLE 2

| Sample # | 234 | 235 | 236 | 240 | 250 |
|---|---|---|---|---|---|
| Cane Molasses | 57.6 | 57.5 | 57.7 | 60.1 | 58.4 |
| Water | 9.6 | 12.0 | 12.0 | 12.0 | 9.0 |
| FeSO₄•H₂O | 8.5 | 8.5 | 8.5 | 8.5 | 8.5 |
| Mg Oxide | 4.6 | 4.6 | 4.6 | 3.8 | 4.6 |
| Wheat Middlings | 7.8 | 7.3 | 7.0 | 3.5 | 7.4 |
| DCF | 3.7 | 3.5 | 3.5 | 3.9 | 3.9 |
| Soybean oil | 4.2 | 4.2 | 4.2 | 4.2 | 4.2 |
| TSPP | 3.7 | 3.6 | 3.6 | 3.7 | 3.7 |
| Saccharin | 0.1 | 0.1 | 0.1 | 0.1 | 0.1 |
| Berry flavor | 0.2 | 0.2 | 0.2 | 0.2 | 0.2 |

TABLE 3

| Sample # | 256 | 257 | 258 | 259 | 260 |
|---|---|---|---|---|---|
| Cane Molasses | 57.7 | 58.4 | 57.7 | 60.0 | 59.0 |
| Water | 8.2 | 8.2 | 9.1 | 9.2 | 8.2 |
| FeSO₄•H₂O | 8.8 | 8.9 | 8.9 | 8.9 | 9.5 |
| Mg Oxide | 4.2 | 3.8 | 3.6 | 3.6 | 3.6 |
| Wheat Middlings | 7.5 | 7.3 | 7.2 | 7.7 | 7.4 |
| DCF | 5.1 | 5.3 | 5.5 | 6.1 | 6.1 |
| Soybean oil | 4.3 | 4.1 | 4.1 | 4.1 | 4.0 |
| TSPP | 3.7 | 3.5 | 3.5 | 0 | 1.6 |
| Saccharin | 0.15 | 0.15 | 0.15 | 0.15 | 0.15 |
| Berry Flavor | 0.25 | 0.25 | 0.25 | 0.25 | 0.25 |

TABLE 4

| Sample # | 262 | 266 | 271 | 281 | 284 |
|---|---|---|---|---|---|
| Cane Molasses | 57.8 | 57.6 | 55.2 | 57.4 | 55.0 |
| Water | 7.3 | 7.5 | 11.0 | 9.0 | 8.0 |
| FeSO₄•H₂O | 9.1 | 9.0 | 9.0 | 9.0 | 9.0 |
| Mg Oxide | 4.6 | 4.8 | 4.4 | 4.6 | 1.4 |
| Wheat Middlings | 7.0 | 6.9 | 7.3 | 4.1 | 4.4 |
| DCF | 6.0 | 6.0 | 5.1 | 4.2 | 4.5 |
| Soybean oil | 4.1 | 4.1 | 4.0 | 7.5 | 7.5 |
| TSPP | 3.7 | 3.7 | 3.6 | 3.6 | 3.5 |
| Saccharin | 0.15 | 0.15 | 0.15 | 0.15 | 0.3 |
| Berry Flavor | 0.25 | 0.25 | 0.25 | 0.25 | 0.4 |
| Whey Permeate | | | | | 6.0 |

TABLE 5

| Sample # | 238 | 271 | 281 | 284 | 288 |
|---|---|---|---|---|---|
| Water | 14.2 | 11.0 | 9.0 | 8.0 | 9.0 |
| Cane Molasses | 59.5 | 55.2 | 57.4 | 55.0 | 53.7 |
| FeSO₄•H₂O | 8.5 | 9.0 | 9.0 | 9.0 | 9.0 |
| Mg Oxide | 2.5 | 4.4 | 4.6 | 1.4 | 4.5 |
| Wheat Middlings | 3.4 | 7.3 | 4.1 | 4.4 | 6.9 |
| DCF | 3.7 | 5.1 | 4.2 | 4.5 | 6.0 |
| Whey Permeate | | | | 6.0 | 2.5 |
| Soybean oil | 4.3 | 4.0 | 7.5 | 7.5 | 4.2 |
| TSPP | 3.6 | 3.6 | 3.6 | 3.5 | 3.6 |
| Saccharin | 0.1 | 0.15 | 0.25 | 0.3 | 0.25 |
| RedBerry Flavor | 0.2 | 0.25 | | 0.4 | 0.35 |
| Strawberry Flavor | | | 0.35 | | |

TABLE 6

| Sample # | 291 | 299 | 300 | 301 |
|---|---|---|---|---|
| Water | 2.0 | 12.0 | 12.0 | 12.0 |
| Cane Molasses | 65.0 | 56.06 | 56.06 | 54.26 |
| FeSO₄•H₂O | 9.0 | 9.0 | 9.0 | 9.0 |
| Mg Oxide | 3.9 | 4.5 | 4.6 | 4.5 |
| Wheat Middlings | 3.0 | 2.4 | 2.5 | 4.0 |
| DCF | 5.0 | 3.5 | 3.7 | 3.5 |
| Whey Permeate | 4.0 | 5.0 | 4.6 | 4.6 |
| Soybean Oil | 4.0 | 4.2 | 4.2 | 4.2 |
| TSPP | 3.5 | 2.5 | 2.5 | 3.1 |
| Saccharin | 0.25 | 0.4 | 0.4 | 0.4 |
| RedBerry Flavor | 0.35 | 0.4 | 0.4 | 0.4 |
| Strawberry Flavor | | | | |
| Methyl Anthranilate | | 0.04 | 0.04 | 0.04 |

TABLE 7

| Sample # | 302 | 303 | 304 | 305 | 306 | 309 | 310 |
|---|---|---|---|---|---|---|---|
| Water | 12.0 | 13.0 | 12.0 | 12.0 | 12.0 | 12.0 | 12.0 |
| Cane Molasses | 54.06 | 53.16 | 53.76 | 53.86 | 53.86 | 53.86 | 53.86 |
| FeSO₄•H₂O | 9.0 | 9.0 | 9.0 | 9.0 | 9.0 | 9.0 | 9.0 |
| Mg Oxide | 4.6 | 4.6 | 4.6 | 4.6 | 4.6 | 4.6 | 4.6 |
| Wheat Middlings | 4.0 | 4.0 | 4.0 | 4.0 | 4.0 | 4.0 | 4.0 |
| DCF | 3.5 | 3.4 | 3.5 | 3.5 | 3.2 | 3.2 | 3.2 |
| Whey Permeate | 4.6 | 4.6 | 4.6 | 4.6 | 4.6 | 4.6 | 4.6 |
| Soybean oil | 4.2 | 4.2 | 4.2 | 4.2 | 4.5 | 4.5 | 4.5 |
| TSPP | 3.2 | 3.2 | 3.5 | 3.4 | 3.4 | 3.4 | 3.4 |
| Saccharin | 0.4 | 0.4 | 0.4 | 0.4 | 0.4 | 0.4 | 0.4 |
| RedBerry Flavor | 0.4 | 0.4 | 0.4 | 0.4 | 0.4 | 0.4 | 0.4 |
| Methyl Anthranilate | 0.04 | 0.04 | 0.04 | 0.04 | 0.04 | 0.04 | 0.04 |

TABLE 8

| Sample # | 311 | 313 | 314 | 315 | 316 | 317 | 392 |
|---|---|---|---|---|---|---|---|
| Water | 11.5 | 11.8 | 11.8 | 11.8 | 11.8 | 11.8 | 10.8 |
| Cane Molasses | 52.35 | 52.24 | 52.24 | 52.24 | 52.44 | 52.44 | 50.1 |
| FeSO₄•H₂O | 9.0 | 9.0 | 9.0 | 9.0 | 9.0 | 9.0 | 12.0 |
| Mg Oxide | 4.6 | 4.6 | 4.6 | 4.6 | 4.6 | 4.6 | 4.7 |
| Wheat Middlings | 3.3 | 3.0 | 2.9 | 2.9 | 3.3 | 3.3 | — |
| DCF | 3.0 | 2.9 | 2.9 | 2.9 | 2.8 | 2.8 | 0.5 |
| Whey Permeate | 6.8 | 7.0 | 7.1 | 7.1 | 6.6 | 6.6 | 10.9 |
| Soybean oil | 5.0 | 5.0 | 5.0 | 5.0 | 5.0 | 5.0 | 5.2 |
| TSPP | 3.6 | 3.6 | 3.6 | 3.6 | 3.6 | 3.6 | 3.6 |
| Saccharin | 0.4 | 0.4 | 0.4 | 0.4 | 0.4 | 0.4 | 0.7 |
| RedBerry Flavor | 0.4 | 0.4 | 0.4 | 0.4 | 0.4 | 0.4 | 0.7 |
| Methyl Anthranilate | 0.05 | 0.06 | 0.06 | 0.06 | 0.06 | 0.06 | 0.1 |
| Oat groats | — | — | — | — | — | — | 0.7 |

### Example 3—a General Preparation of Solid Form Nutrient Compositions in the Form of Granular Materials

The following dry ingredients listed are first added to a Mix Master Mixer or Hobart Mixer: dried cane molasses with beet sugar pulp absorbent, whey permeate (when used), degerminated corn flour, wheat middlings, ferrous sulfate monohydrate, tetrasodium pyrophosphate, magnesium oxide (Such as HR 93X), saccharin, and berry flavor.

The liquid ingredients are next added to the mixer prior to mixing in the following order: cane molasses, soybean oil, and methyl anthranilate.

The total batch is mixed for 8 minutes. The batch is poured onto a metal tray table to air dry. After air drying for 1 hour the product is bagged in 25 lb. polylined bags. A typical batch size is between about 800 to 1000 g.

### Example 4

The following weight percent compositions for granular forms as set forth in Tables 9-13 were made according to the general procedures of Example 3.

TABLE 9

| Sample # | 220 | 237 | 239 | 241 | 242 | 243 |
|---|---|---|---|---|---|---|
| Dry Molasses | — | — | — | — | — | — |
| Cane Molasses | 20.0 | 30.0 | 30.0 | 30.0 | 30.0 | 30.0 |
| DCF | — | 33.0 | 33.0 | 33.0 | 33.0 | 33.0 |
| Wheat Middlings | 62.2 | 24.7 | 24.7 | 24.7 | 24.7 | 24.7 |
| FeSO₄•H₂O | 8.5 | 8.5 | 8.5 | 8.5 | 8.5 | 8.5 |
| Mg Oxide | 3.0 | 1.7 | 1.7 | 1.7 | 1.7 | 1.7 |
| TSPP | 2.1 | 1.8 | 1.8 | 1.8 | 1.8 | 1.8 |
| Saccharin | — | 0.1 | 0.1 | 0.1 | 0.1 | 0.1 |
| Strawberry flavor | — | — | — | 0.2 | — | — |
| Dairy flavor | — | — | 0.2 | — | — | — |
| Berry flavor | — | 0.2 | — | — | 0.2 | 0.2 |
| Corn Cob Meal | 4.0 | — | — | — | — | — |

TABLE 10

| Sample # | 244 | 245 | 246 | 247 | 248 | 249 |
|---|---|---|---|---|---|---|
| Dry Molasses | — | — | — | — | — | — |
| Cane Molasses | 30.0 | 30.0 | 33.0 | 34.0 | 30.2 | 30.3 |
| DCF | 33.0 | 33.0 | 33.0 | 33.0 | 33.0 | 33.0 |
| Wheat Middlings | 24.7 | 25.0 | 22.0 | 21.0 | 24.6 | 24.5 |
| FeSO₄•H₂O | 8.5 | 8.5 | 8.5 | 8.5 | 8.5 | 8.5 |
| Mg Oxide | 1.7 | 1.7 | 1.7 | 1.7 | 1.7 | 1.7 |
| TSPP | 1.8 | 1.5 | 1.5 | 1.5 | 1.7 | 1.7 |
| Saccharin | 0.1 | 0.1 | 0.1 | 0.1 | 0.1 | 0.1 |
| Strawberry flavor | — | — | — | 0.2 | — | — |
| Dairy flavor | — | — | — | — | — | — |
| Berry flavor | 0.2 | 0.2 | 0.2 | — | 0.2 | 0.2 |

TABLE 11

| Sample # | 251 | 252 | 253 | 254 | 255 | 272 |
|---|---|---|---|---|---|---|
| Dry Molasses | — | — | — | — | — | 23.0 |
| Cane Molasses | 29.0 | 29.0 | 29.0 | 29.0 | 29.0 | 5.0 |
| DCF | 31.8 | 31.8 | 31.8 | 30.8 | 30.9 | 29.3 |
| Wheat Middlings | 25.0 | 25.0 | 25.0 | 26.0 | 25.0 | 27.0 |
| FeSO₄•H₂O | 8.5 | 8.8 | 8.8 | 8.8 | 8.8 | 9.0 |
| Mg Oxide | 1.7 | 1.5 | 1.5 | 1.5 | 1.5 | 1.5 |
| Soybean oil | 2.0 | 2.0 | 2.0 | 2.0 | 2.9 | 3.2 |
| TSPP | 1.7 | 1.6 | 1.6 | 1.6 | 1.6 | 1.6 |
| Saccharin | 0.1 | 0.1 | 0.1 | 0.1 | 0.1 | 0.15 |
| Strawberry flavor | 0.2 | 0.2 | 0.2 | 0.2 | 0.2 | 0.25 |

TABLE 12

| Sample # | 272 | 274 | 277 | 280 | 282 | 283 | 285 |
|---|---|---|---|---|---|---|---|
| Dry Molasses | 23.0 | — | 12.0 | 27.5 | — | 17.0 | 23.0 |
| Cane Molasses | 5.0 | 28.0 | 20.0 | 5.0 | 27.0 | 10.0 | 10.0 |
| DCF | 29.3 | 29.3 | 32.0 | 21.8 | 26.0 | 26.0 | 22.7 |
| Wheat Middlings | 27.0 | 27.0 | 20.5 | 21.8 | 24.0 | 24.3 | 22.7 |
| FeSO₄•H₂O | 9.0 | 9.0 | 9.0 | 8.9 | 9.0 | 9.0 | 9.0 |
| Mg Oxide | 1.5 | 1.5 | 1.5 | 1.5 | 1.5 | 1.5 | 1.5 |
| Soybean oil | 3.2 | 3.2 | 2.8 | 2.9 | 3.0 | 3.0 | 2.9 |
| Whey Permeate | — | — | — | 8.5 | 7.0 | 7.0 | 6.0 |
| TSPP | 1.6 | 1.6 | 1.6 | 1.5 | 1.6 | 1.6 | 1.5 |
| Saccharin | 0.15 | 0.15 | 0.25 | 0.25 | 0.25 | 0.3 | 0.3 |
| Strawberry flavor | 0.25 | 0.25 | 0.35 | 0.35 | 0.35 | 0.4 | 0.4 |

TABLE 13

| Sample # | 298 | 307 | 308 | 318 | 319 | 320 |
|---|---|---|---|---|---|---|
| Dry Cane Molasses | 34.96 | 34.66 | 34.66 | 35.64 | 35.64 | 35.64 |
| Cane Molasses | 10.00 | 10.00 | 10.00 | 10.00 | 10.00 | 10.00 |
| Whey Permeate | 10.00 | 10.00 | 10.00 | 18.00 | 18.00 | 18.00 |
| DCF | 20.00 | 20.00 | 20.00 | 12.00 | 12.00 | 11.50 |
| Wheat Middlings | 9.00 | 9.00 | 9.00 | 9.00 | 9.00 | 8.60 |
| FeSO₄•H₂O | 9.00 | 9.00 | 9.00 | 8.00 | 8.00 | 9.00 |
| Magnesium Oxide | 1.00 | 1.10 | 1.10 | 1.10 | 1.10 | 1.00 |
| Soybean oil | 4.00 | 4.00 | 4.00 | 4.00 | 4.00 | 4.00 |
| TSPP | 1.20 | 1.40 | 1.40 | 1.40 | 1.40 | 1.40 |
| Saccharin | 0.40 | 0.40 | 0.40 | 0.40 | 0.40 | 0.40 |
| RedBerry flavor | 0.40 | 0.40 | 0.40 | 0.40 | 0.40 | 0.40 |
| Methyl Anthranilate | 0.04 | 0.04 | 0.04 | 0.06 | 0.06 | 0.06 |

### Example 5—Observations of Infant Pigs Treated by Solid Form Nutrient Compositions

Five blocks each of sample numbers 305, 306, and 309 and four block each of sample numbers 310 and 311 were tested with multiple infant pig litters. All pigs who consumed the blocks (including where no injections were given) showed a strong pink color through weaning, at least as strong as those given two injections of iron dextran. Such pigs were also found to behave equally aggressively as pigs given two injections of iron dextran, but not given blocks. These observations indicate that pigs fed only blocks did not suffer from anemia and fared at least as well as pigs given two injections of iron dextran as per typical procedure.

### Example 6—Hemoglobin Measurement of Pigs Treated with Solid Form Nutrient Compositions in the Form of Granular Materials

TABLE 14

| | Granular | 1 Injection | 2 Injections |
|---|---|---|---|
| Pigs in Litter | 13 | 12 | 7 |
| Pigs >10 gm % | 11 | 2 | 5 |
| Pigs <10 gm % | 2 | 10 | 2 |
| Pigs in Litter | 10 | 10 | 11 |
| Pigs >10 gm % | 10 | 6 | 9 |
| Pigs <10 gm % | 0 | 4 | 2 |
| Pigs in Litter | 8 | — | — |
| Pigs >10 gm % | 6 | — | — |
| Pigs <10 gm % | 2 | — | — |
| Pigs in Litter | 11 | — | — |
| Pigs >10 gm % | 11 | — | — |
| Pigs <10 gm % | 0 | — | — |
| Total # Pigs | 42 | 22 | 18 |
| Pigs >10 gm % | 38 | 8 | 14 |
| Pigs <10 gm % | 4 | 14 | 4 |
| % with adequate Hemoglobin | 90.4 | 36 | 77 |

In Example 6, four litters of pigs were provided granular product (sample numbers 272 and 280). These litters were offered these granular products ad litum from birth to 21 days of birth. Two litters were not offered granular material, but were instead injected with iron dextran on day 3 after birth with 1 cc of 200 mg of iron dextran. Two other litters, also not offered granular material, were injected twice, once on day 3, and once on day 10 after birth. Each injection was a 1 cc injection of 200 mg of iron dextran.

The granular iron was offered ad libitum to nursing pigs from birth to 21 days of age and provides significantly more iron in support of normal hemoglobin than injection of iron dextran at the level recommended by the manufacturer. The National Research Council in the Nutrient Requirement of Swine publication recommends that levels of iron dextran providing more than 200 mg per pig in one injection be avoided. Many producers provide a second injection to minimize the deficiency which doubles the cost of preventing anemia in young pigs, and increases the probability of spreading pathogens with needles.

Hemoglobin analysis is an excellent way to quantitate the adequacy of iron for the pig but the treatment differences are obvious by just viewing the litters. Pigs with adequate hemoglobin have better color and are much more active and aggressive whether nursing or simply activity in the pen. In the case of Example 6, not only were hemoglobin levels significantly superior for most of the pigs treated with granular products of the invention, but their skin color and behavior was also superior to those of the pigs given standard iron dextran injections.

A striking difference between healthy hemoglobin adequate pigs and anemic pigs is the color of the skin. This is most obvious in white pigs, and most pigs in US have some white color in their breed lineage. Pigs with hemoglobin values above 10 gm per 100 ml. have extremely bright, pink skin, while anemic pigs have very pale almost white color of the skin.

1. A solid form nutrient composition comprising a nutrient, a carbohydrate energy source, one or more nutritional fillers, and milk solids.

2. The solid form nutrient composition of claim 1 in block form wherein the carbohydrate energy source is cane molasses and further comprising water, a dispersant, a metal oxide, a sweetener, a promoting agent and methyl anthranilate.

3. The solid form nutrient composition of claim 2, wherein the nutrient is an iron source.

4. The solid form nutrient composition of claim 3, wherein the iron source is iron sulfate or a hydrate thereof.

5. The solid form nutrient composition of claim 4, wherein the nutritional filler is one or more of wheat middlings, degerminated corn flour, oat groats, or corncob meal and the milk solids are whey permeate.

6. The solid form nutrient composition of claim 5, wherein the whey permeate contains lactose.

7. The solid form nutrient composition of claim 6, wherein the whey permeate is greater than 50% lactose by weight.

8. The solid form nutrient composition of claim 7, wherein the whey permeate is greater than 60% lactose by weight.

9. The solid form nutrient composition of claim 7, wherein the nutritional filler is degerminated corn flour and oat groats.

10. The solid form nutrient composition of claim 9, wherein the dispersant is tetrasodium pyrophosphate, the metal oxide is magnesium oxide, the promoting agent is soybean oil, the sweetener is saccharin and further comprising a flavoring.

11. The solid form nutrient composition of claim 10, wherein the flavoring is a berry flavoring, and the solid form nutrient composition is substantially free of clay fillers.

12. The solid form nutrient composition in block form of claim 1 comprising, by weight, between about 7% and about 15% of the nutrient wherein the nutrient is ferrous sulfate or a hydrate thereof, between about 45% to about 54% of the carbohydrate energy source wherein the carbohydrate energy source is cane molasses, between about 0.5% and about 5% of nutritional fillers, and between about 4% and about 20% of milk solids.

13. The solid form nutrient composition of claim 12, wherein the nutrient is ferrous sulfate monohydrate, the nutritional fillers comprise one or more of degerminated corn flour and oat groats, and the milks solids are whey permeate.

14. The solid form nutrient composition of claim 13, further comprising, by weight, between about 5% and about 20% water, between about 3% and about 7% of soybean oil, between about 2% and about 6% of a dispersant, and between about 3% and about 7% of magnesium oxide.

15. The solid form nutrient composition of claim 14, further comprising a sweetener, a flavoring, and methyl anthranilate wherein the dispersant is tetrasodium pyrophosphate.

16. The solid form composition of claim 15, wherein the amount of methyl anthranilate is between about 0.01% and about 0.1%, and the sweetener is saccharin.

17. A method of increasing the hemoglobin content of infant pigs by feeding said pigs a solid form nutrient composition of claim 1.

18. A solid form block composition prepared by combining a mixture comprising cane molasses, water, soybean oil, and methyl anthranilate with a mixture comprising whey permeate, nutritional fillers, and ferrous sulfate monohydrate, a dispersant and a metal oxide to form a liquid; and drying the liquid in a container to form blocks.

19. The solid form block composition of claim 18, wherein the amount of cane molasses is between about 45% and about 54%, the amount of whey permeate is between about 6% and about 12%, and the amount of ferrous sulfate monohydrate is between about 11% and about 13%, and oat groats is a nutritional filler.

20. The solid form block composition of claim 19, wherein the dispersant is tetrasodium pyrophosphate, the metal oxide is magnesium oxide, and further comprising a sweetener and a flavoring.
